(19) United States
(12) Patent Application Publication
(10) Pub. No.: US 2008/0001784 A1
(43) Pub. Date: Jan. 3, 2008

(54) GLOBAL CONTROL SYSTEM FOR TERRITORIAL PROTECTION

(76) Inventor: Carmelo PAGANO, Toarmina (ME) (IT)

Correspondence Address: YOUNG & THOMPSON, 745 SOUTH 23RD STREET, 2ND FLOOR, ARLINGTON, VA, 22202, US

(21) Appl. No.: 11/769,056

(22) Filed: Jun. 27, 2007

(30) Foreign Application Priority Data
Jun. 28, 2006 (EP) 1 675 084 A1

(51) Int. Cl. G08G 1/127

(52) U.S. Cl. 340/989

(57) ABSTRACT

Global control system for the protection of the territory, comprising in combination fixed central units intended to be installed in a distributed way on the territory; mobile central units intended to be installed on transportation means of both road and railway and ship and air transportation networks; operating central units; the fixed and mobile central units being endowed with sensing means; and the fixed central units, the mobile central units and the operating central units being endowed with communication means for communicating information therebetween, as well as being endowed with programmable data processing means.

### FIELD OF THE INVENTION

The present invention relates to an electronic system for monitoring and controlling land for the protection against dangerous abnormality conditions that may take place therein.

### BACKGROUND OF THE INVENTION

On land abnormal conditions or dangerous abnormalities may take place, that require a protective intervention that restores the state of normality. By “abnormality” it is meant in the present application any condition that brings harm or danger to public safety, such as e.g. a violations of law, terrorist attacks, dangerous environmental conditions such as dense fog or disasters such as the collapse of a bridge, etc. In order to identify and correct the abnormalities it is necessary to be able to accomplish two functionalities: (1) sensing an abnormality in real time; (2) an equally timely protective intervention for restoring normality.

A structure does not exist at present that allows these functionalities to be realized in a systematic and capillary, as well as automated way.

A particular case of great importance is the safety on traffic networks of transportation means, particularly on the road network.

For the purposes of the safety on the road, for the detection od abnormalities monitoring systems are used at present that, however, just have the shortcoming of not performing their function in a systematic and capillary way, and of requiring the mobilization of human resources. This is the case for example of the systems for detecting speed such as Autovelox. A violation of law on the road is for example driving without law requisites, such as for example an expired driving licence; in this case too inspections are not systematic and envisage some personnel, i.e. they are not automated.

In addition to the speed of vehicles, safety distance is of a primary importance for the safety on the road. In this case too present measures are insufficient; moreover, whilst the speed is unequivocally indicated in the various road tracts by precise limits, the there is the shortcoming that the safety distance is not ruled precisely, but only approximately indicated as a function of speed and of environmental conditions.

Therefore, a monitoring and a control of land against abnormalities are still lacking, that are performed in a systematic and capillary, as well as automated way, for the purposes of a starting of a protective intervention in real time for the recovery of normality.

The present invention puts itself the general object of fulfilling such a lack.

The present invention, moreover, poses itself the particular object of providing means for guaranteeing a substantially greater safety on the roads.

The present invention reaches such an object availing itself of the possibilities of sensing, of data processing and telecommunicating presently offered by Electronics and by transmission and communication systems, i.e. by sensors, actuators, transmission lines and radiocommunication means, envisaging the possibility of utilizing preexistent systems such as telephone lines, GPS system (Global Positioning System) end possibly electric energy transportation lines.

The present invention affords a multiplicity of important advantages. By virtue of it a capillary monitoring turns out to be possible of the whole road network, the urban, the extra-urban and the motorway one, particularly in the sections having a greater vehicle flow and/or of a high danger; it turns out to be possible to substitute the traditional devices for detecting the speed in traffic; particularly, the detection of speed can be carried out without the intervention of a human operator; in addition to verifying the respect of rules, a protective intervention is possible against non-fulfilments of rules, through remote intervention on vehicles that do them; particularly, one can force the respect of safety distance; particularly, by virtue of the present invention it is possible to eliminate phenomena such as clandestine races on the road network; it is possible to considerably increase the safety on the roads especially in the periods of great exodus, avoiding that reckless drivers cause danger; the installation of the inventive system involves a very considerable reduction of road accidents, also because all the users of the road will acknowledge the fact that any violation can be immediately ascertained and therefore they will have to answer for it surely and immediately. In case of road piracy, with the system of the present invention the vehicle that does it turns out to be immediately identifiable, and an intervention is possible against it in real time as well. With the inventive system it turns out to be possible to monitor entire zones or road sections, blocking entire road sections and interdicting the traffic in zones of urban conglomerations. It is possible to make the Highway Code to be respected particularly in proximity with schools, crossroads and dangerous bends, in proximity with public bureaus, military areas, bathing zones. It is possible to repress road piracy actions, occasional clandestine competitions, tough guy manifestations, exhibitions of reckless drivers, to eliminate any sporting foolish ambition, especially during weekend returns or in summer and winter exodus.

### BRIEF SUMMARY OF THE INVENTION

Therefore it is the subject of the present invention a global control system for the protection of the territory, comprising in combination fixed central units intended to be installed in a distributed way on the territory; mobile central units intended to be installed on transportation means of both road and railway and ship and air transportation networks; operating central units; the fixed and mobile central units being endowed with sensing means; and the fixed central units, the mobile central units and the operating central units being endowed with communication means for communicating information therebetween, as well as being endowed with programmable data processing means.

### DETAILED DESCRIPTION OF THE INVENTION

The present invention will be understood on the basis of the following detailed disclosure, exclusively given as a matter of example, absolutely not of restriction thereof.

The present invention is directed to provide a system for monitoring and controlling land against the abnormalities that can take place therein. It is envisaged that the system of the present invention can foresee, for the realization thereof, constituting a common organization among countries that have a high technologic development. The inventive system is based on the arrangement of fixed central units (FC) for sensing and data processing fixed in a distributed way on land, and on the installation of mobile central units (MC) for sensing and data processing on all locomotion means both road and railway, and air and naval ones.

FCs and MCs are endowed with sensors and processing data units programmed for performing a series of functions. FCs and MCs, moreover, are endowed with transceivers

FCs and MCs can be endowed for example with sensors of temperature, of gas presence, of inundation, of seismic shock, of smoke, of moisture, of bacterial pollution.

MCs can be endowed with means for sensing the safety distance between vehicles that compute the relative speed, for example through radar means; moreover, they can be endowed with sensors of physical magnitudes, to keep atmospheric conditions into account in computing the safety distance.

The inventive system is managed by operating central units (OC), which can be fixed or transported as well, for example as equipment for patrols, endowed with data processing means programmed for determined functionalities, and with transceivers for receiving data and detections transmitted by the FCs and MCs and send commands thereto.

The function of an MC is to identify both the vehicle (for example an automobile) on which it is installed, and the driver of the vehicle. The MC is intended to give or not to give the consent to the ignition of the motor to the driver as a function of the qualification of the driver's licence. A title in electronic format for enabling driving is provided, intended to cooperate with an MC, in which title all data are registered for identifying the owner, as well as all the information relevant for the purposes of driving, such as e.g. health conditions, as well as the legal and judicial status of a driver. MCs comprise means for inputting and reading the drive enabling title in electronic format. The consent to use the vehicle will only be given by the MC to the driver if there are not impedimental elements.

MCs are interfaced with the electric plant of the motor of a vehicle in order to be able to limit the revolutions per minute, for example upon command of OC. They can command the block of the motor to prevent the use of the vehicle.

An MC can also grant a restricted use of a vehicle; particularly, it can exclude recently qualified drivers from utilizing vehicles having a power greater than that allowed to them. An MC can also limit the maximum speed of the vehicle for the recently qualified driver; when the document is inserted, a command intervenes that restricts the maximum revolutions per minute in direct drive.

The owner of a transportation means, particularly a firm or another legal person, can limit the use of the transportation means itself only to determined other subjects, with the further possibility of programming the use itself. More specifically, a firm for example can leave an automobile in use to an appointee of its own only in working days, to restrict the use by sure means to only actually working days.

An MC can be programmed to command the block of a truck in case the truck driver fails to observe the regulations in force in the merit of the compulsory intervals prescribed.

Moreover, the MCs can hold data registered inhering to the movements of a vehicle and of a driver, and send them to a OC for memorizing them in a data bank associated therewith. So, from the updatable data bank, it is possible to reconstruct a historical log of the movements of a vehicle based on its identification.

The communication between MCs, FCs and OCs for sending sensings and commands can take place through already existent links such as e.g. with the aid of transceiver links, by making use of system GPS (Global Positioning System), by cable.

For example, if along a motorway section covered by fixed central units identified from No. 2301 to No. 2400 an anomalous event happens, the OC, informed thereabout, is able—for example relying on system GPS—to broadcast a command to the FCs, and these ones forward it to the MCs transported by the vehicles that travel thereon.

It is envisaged that an OC is endowed with means for interfacing with luminous road signage (e.g. traffic lights), so that the OCs are able to send signalling messages therethrough.

The MCs can be endowed with means for the recognition of the failed respect of the safety distance as an abnormality, and to signalize that to both the driver and the operating central unit. The signalling to the driver can be an intermittent signal, having an increasing/decreasing rate as the distance between vehicles increases/decreases. On the part of the operating central unit, it is provided that this one sends a command for limiting the revolutions per minute to the MC to restore the safety distance. Luminous signallers are functionally associated to an MC, that turn on when the limited modality intervenes, warning the vehicles that follow about the slowing in progress with a luminous signalling (similarly to what happens when braking). The moment of the abnormality overcome, the operation restarts regularly.

Another abnormal situation is riding a road in the wrong direction; in this case the OC can force the blocking of the vehicle.

Still it is envisaged that an OC through the MC can apply the blocking of the vehicles that ride in an entire zone if the latter turns out to be affected by an anomalous event, such as e.g. robbery or terrorist action.

The MCs are intended to be assembled in an easily identifiable and accessible way, but in a safe way and sealed or anyhow endowed with anti-tampering means, so that one can nor tamper, nor disassemble them in a quick and easy way.

Through a FC it is possible to signal an abnormality to an OC such as the collapse of a bridge. A FC installed to monitor the state of a bridge can be equipped with a continuity means that break at the collapse of the bridge, sending a signal to the FC, which forwards the signal to the OC, which provides for signalling the abnormality.

The present invention has been described with reference to specific embodiments thereof, but it is to be understood that it remains restricted only by the annexed claims.

1. Global control system for the protection of territory, including in combination:
fixed central units intended to be installed in a distributed way on the territory;
mobile central units intended to be installed on transportation means on both road and railway and ship and air transportation networks;
operating central units;
said fixed central units and mobile central units being endowed with sensing means;
and said fixed central units, mobile central units and operating central units being endowed with communication means to communicate information therebetween, as well as being endowed with programmable data processing means.

2. The system of claim 1, wherein said mobile central units are endowed with means for detecting violations to traffic regulations by the transportation means whereupon they are installed.

3. The system of claim 1 wherein said mobile central units are endowed with means for detecting the speed of a transportation means and of the violation of a speed limit by the transportation means itself.

4. The system of claim 1 wherein said mobile central units are endowed with means for detecting the safety distance between transportation means and the violation by a transportation means of a determined safety distance with respect to a transportation means preceding it.

5. The system of claim 1 wherein said mobile central units are endowed with means for limiting the revolutions per minute of the motor of the transportation means whereon the mobile central units are assembled to force the observance of a speed limit or of a safety distance by the transportation means.

6. The system of claim 1, wherein said mobile central units are endowed with means for reading a document qualifying to the driving of the transportation means on which they are installed, and with means for enabling/disabling the consent to the ignition of the motor of a transportation means as a consequence of the fact that the result of the reading of said qualifying document is positive or respectively negative.
